(19) United States
(12) Patent Application Publication
(10) Pub. No.: US 2007/0147758 A1
(43) Pub. Date: Jun. 28, 2007

(54) Light integrator with circular light output

(75) Inventor: Christopher Cummings, Hampton, NH (US)

Correspondence Address: ANTONIO R. DURANDO, 6902 N. TABLE MOUNTAIN ROAD, TUCSON, AZ, 85718-1331, US

(73) Assignee: EDMUND OPTICS, INC., BARRINGTON, NJ (US)

(21) Appl. No.: 11/526,521

(22) Filed: Sep. 25, 2006

Related U.S. Application Data
(60) Provisional application No. 60/721,335, filed on Sep. 26, 2005.

(51) Int. Cl. G02B 6/10

(52) U.S. Cl. 385/129

(57) ABSTRACT

An ILP comprises a rotationally symmetric surface in an outer structure serving as a spatial limiter and an inner optical surface that is rotationally asymmetric in cross-section disposed lengthwise within the outer structure. The inner surface acts as a conventional light-integrator and is designed to allow a portion of the homogenized light to spread toward the rotationally symmetric surface upon propagation. As a result, by the time the light reaches the end of the ILP, the entire circular area at its output facet is filled with uniform-irradiance light.

### RELATED APPLICATIONS

This application is based on U.S. Provisional Application No. 60/721,335, filed Sep. 26, 2005.

### BACKGROUND OF THE INVENTION

1. Field of the Invention

This invention relates in general to optical devices that spatially homogenize light produced by non-homogenous optical sources. In particular, it relates to methods and systems that utilize integrating lightpipes producing a light output characterized by a uniform irradiance distribution and a circular cross-sectional profile.

2. Description of the Related Art.

Illumination systems that utilize various sources of light, whether mono- or poly-chromatic—such as light bulbs, light-emitting diodes (LEDs), or even laser sources—often produce light outputs that are deficient for illumination purposes in that either the irradiance or the intensity (or, both) are not uniform. As understood in the art, the terms “irradiance” and “intensity” are used to describe the distribution of light, and are defined as complementing terms expressed in Cartesian (rectilinear) and spherical (angular) coordinates, respectively. Accordingly, for the purposes of this disclosure the term “irradiance” is used to refer to the flux of radiant energy flowing across a unit area of real or imaginary surface. The term “intensity,” on the other hand, refers to the flux of radiant energy propagating in a given direction per unit of solid angle. The illumination of objects with non-homogeneously distributed light generally degrades the quality and precision of optical imaging. Although the specific impact of non-uniformity in light output varies, the effect is generally undesirable and performance-limiting for most visual- and sensor-based applications and is particularly pronounced when a broadband source (or a combination of spectrally different sources, such as an array of LEDs) is used.

One known practical way of increasing the uniformity of the light output in an optical system is through the use of an integrating lightpipe (ILP); that is, a pipe capable of homogenizing the light propagating within it and creating a uniform distribution of irradiance at the output. For the purposes of this disclosure, the term “lightpipe” refers to an elongated light-guiding transparent medium with cross-sectional dimensions much greater than the wavelength(s) of the guided light. The propagation of the light through the pipe may be accurately described using geometric, ray-optic techniques. For example, the cross-sectional dimensions of a typical lightpipe guiding light in the visible portion of the spectrum are on the order of a centimeter or more, as the situation may require. The skilled person in the art would readily understand that a lightpipe differs in that regard from a typical single-mode fiber optic component, the operation of which cannot be fully described in terms of ray optics but requires a precise wave-optics approach.

The light-scrambling capability of an ILP, which is responsible for the homogenization of light irradiance, is due to the rotationally asymmetric shape of the pipe. As used in this disclosure, the terms “rotationally (a)symmetric,” “rotational (a)symmetry” and other shape designations (such as “circular” or “polygonal”) refer to the shape of the cross-section perpendicular to the optical axis of the item under discussion (such as a lightpipe or a light output). The term “optical axis” refers to the imaginary line defining the path along which light propagates through the system. For simplicity of fabrication, typical ILPs have polygonal cross-sectional profiles (such as rectangular, or hexagonal, for example), but any other irregular, rotationally asymmetric cross-section (such as trapezoidal) may be used. Prior-art ILPs may be formed by appropriately shaping a dielectric medium (e.g., forming a polygonal glass rod), or by providing a tubular wall with a reflective inner surface, which defines the light-guiding region and has an appropriate rotationally asymmetric cross-section. In contrast, as is well understood in the art, conventional lightpipes possessing rotational symmetry throughout are not capable of homogenizing light irradiance. This difference in performance is illustrated clearly in FIGS. 1A and 1B, wherein the non-uniform output of a circular lightpipe (1A) is shown next to the much more uniform output of a conventional hexagonal integrating pipe (1B).

As mentioned, because of their cross-sectional configuration, prior-art ILPs do not produce a spatially homogenized light output that is rotationally symmetric. This fact has made the use of ILPs deficient for the purposes of efficiently illuminating the rotationally symmetric apertures to which lightpipes are commonly coupled. Indeed, as illustrated in FIGS. 2A and 2B for the case of a hexagonal ILP, depending on the relative sizes of the light-output's cross-section and the circular FOV to be illuminated, either the FOV is illuminated incompletely or a portion of the homogenized light is lost outside the FOV. In the case of an “underfilled” FOV, illustrated in FIG. 2A, the ratio of the area of the circumscribed hexagon to that of the circle is about 0.83; therefore, about 17% of the FOV is not illuminated. When the same circular FOV is “overfilled,” as shown in FIG. 2B, the ratio of the area of the inscribed circle to that of the hexagon is about 0.91 and about 9% of the light is lost for the purposes of FOV illumination. Similar tradeoffs may exist at the input side of the lightpipe. Therefore, it would be very desirable to have a lightpipe capable of producing a circular homogenized output matching the input of conventional optical systems, so that the homogenizing lightpipe could be coupled with maximum efficiency.

### BRIEF DESCRIPTION OF THE INVENTION

As mentioned, a typical ILP alters the spatial distribution of propagating light due to the rotational asymmetry of the reflective surface at the boundary of the ILP, thereby producing a homogeneous irradiance profile at the lightpipe output with the design tradeoff of introducing rotational asymmetry at the output. This invention addresses the challenge of producing a circular homogenized light distribution with an integrating lightpipe by combining in a single ILP both rotationally symmetric and rotationally asymmetric optical features. The feature that interrupts the rotational symmetry of the ILP serves to homogenize the irradiance distribution of the light output, while the rotationally symmetric feature assures that the overall cross-sectional profile of the light output remains sufficiently circular for coupling with optimal efficiency to the correspondingly circular input of an optical device.

In the most general embodiment of the invention, the ILP comprises two optically reflective surfaces—a rotationally symmetric surface in an outer structure, serving as a spatial limiter to the light contained within the ILP, and an inner optical surface that is rotationally asymmetric in cross-section and disposed lengthwise within the outer structure. The inner surface acts as a conventional light-integrator, simultaneously guiding and homogenizing the light launched into it at the input facet of the ILP and designed to allow a portion of the homogenized light to spread toward the rotationally symmetric surface upon propagation. As a result, by the time the light reaches the end of the ILP, the entire circular area at its output facet is filled with uniform-irradiance light.

The spreading of homogenized light from the inner optical structure to the outer tube of the ILP may be produced in various manners. For example, the termination of the inner structure before the end of the outer tube along the length of the ILP allows spreading of the homogenized light to fill the circular section of the outer tube and be further guided toward the output facet of the ILP by its rotationally symmetric surface. On the other hand, homogenized light may be leaked gradually to the outer tube by having the boundary of the inner optical structure of the ILP be semitransparent to the light propagated within it. This condition would allow the light to bounce in and out of the homogenizing inner structure upon propagation and continuously fill the outer spaces within the circular aperture of the ILP, thereby producing a substantially homogenized circular output.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but a few of the various ways in which the invention may be practiced.

### BRIEF DESCRIPTION OF THE DRAWINGS

FIGS. 1A and 1B illustrate, respectively, the non-uniform irradiance distribution in a cylindrical lightpipe with the light-homogenized output of a prior-art polygonal ILP, which illustrates the uniform irradiance distribution produced thereby.

FIGS. 2A and 2B illustrate the operational inefficiency of a prior-art polygonal ILP to illuminate a circular field -of view without loss of light.

FIG. 3 provides a perspective view of a generic embodiment of the ILP of the invention.

FIGS. 4A and 4B show transverse and longitudinal sections, respectively, of the embodiment of FIG. 3.

FIGS. 5A, 5B and 5C illustrate transverse and longitudinal sections of alternative, preferred, embodiments of the invention.

FIG. 6 shows the uniform distribution of light irradiance across the output facet of the embodiment of the invention of FIG. 5.

FIG. 7 shows a transverse section of another alternative embodiment of the invention with a circular output.

FIG. 8 illustrates a transverse section of an additional alternative embodiment of the invention with a circular output.

FIG. 9 illustrates a transverse section of yet another alternative embodiment of the invention.

FIG. 10 shows a longitudinal section of a further alternative embodiment of the invention with a circular output.

FIG. 11 is a transverse section of one more alternative embodiment of the invention.

FIG. 12 shows a perspective view of an alternative embodiment of the invention with a frustoconical reflective surface bent in space along the optical axis of the pipe.

### DETAILED DESCRIPTION OF THE EMBODIMENTS OF THE INVENTION

As is well understood in the art, lightpipes that are rotationally symmetric with respect to the optical axis are not capable of optimizing the homogeneity of propagating light. Lightpipes with rotationally asymmetric or non-uniform cross-sections, on the other hand, do increase the uniformity of light irradiance at the lightpipe output. This invention lies in the discovery that the judicious placement of rotationally asymmetric reflective surfaces in the inner structure of a rotationally symmetric lightpipe allows for the homogenization of light irradiance within the full, circular cross-section of the pipe, thus providing an ILP with a rotationally symmetric, irradiance-homogenized, light output, as is much desired for the purposes of high-efficiency illumination.

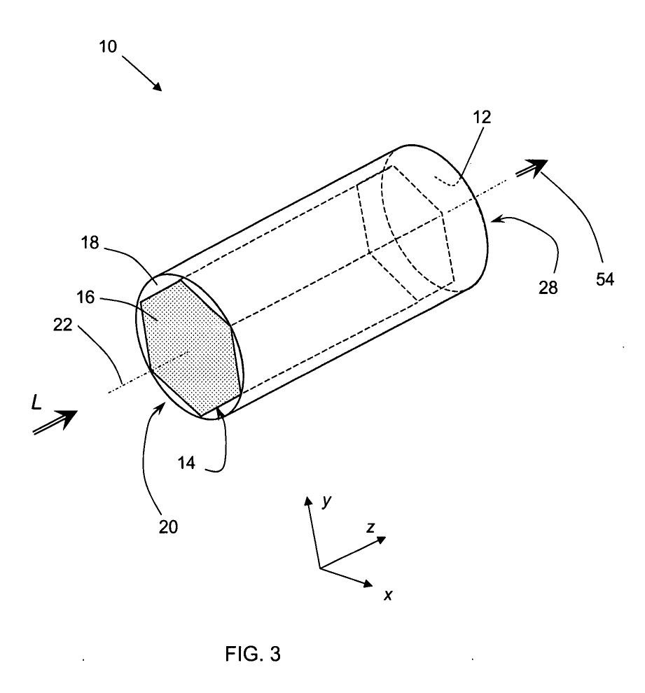

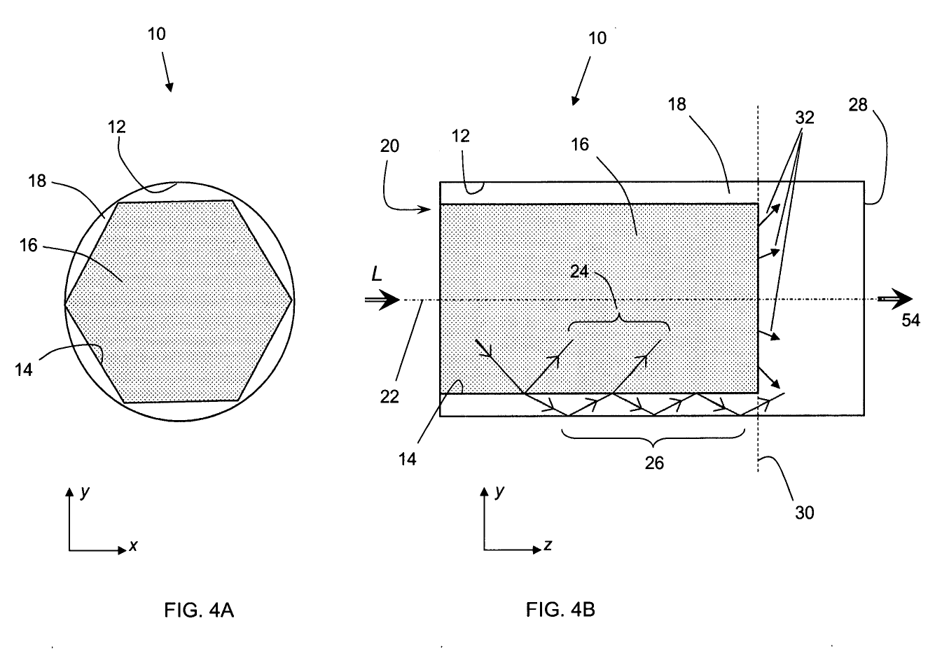

The structural symmetry of a cylindrical lightpipe can be disturbed in a variety of ways. In the most general embodiment of the invention shown in FIGS. 3, 4A and 4B, for example, the structural rotational symmetry of an ILP 10 with a cylindrical inner surface 12 characterized by total internal reflection is interrupted by incorporating a polygonal (hexagonal, for example) tubular optical surface 14 into the body of the ILP 10. In a most general sense, the surface 14 may be totally or partially reflective, as defined by the refractive indices of the optical media filling the spaces 16 and 18 (located inside the surface 14 and between the surfaces 12 and 14, respectively), as well as by the spectral and initial spatial distribution of the light and its polarization. However, particular combinations of structures and refractive indices are much preferred, as will be detailed below. Still referring to FIGS. 4A and 4B, when a high-numerical-aperture bundle of light L is appropriately launched into the ILP 10 through its input facet 20 in the general direction of the optical axis 22, the light propagating within the ILP 10 would generally be both reflecting and transmitting at the surface 14 and reflecting at the surface 12. In the case when the space 16 is optically denser than the space 18, the portion of light 24 propagating within the space 16 bounded by surface 14 includes the fraction of light experiencing total internal reflection (TIR) at the surface 14 and the fraction of light transmitted through the surface 14 and reflected back from the surface 12. At the same time, the light transmitted through the surface 14 from the inner space 16 (i.e., the light incident within the critical angle of TIR) and bouncing between the surface 12 and the outer side of surface 14 constitutes light 26 that propagates through the outer spaces 18.

A similar situation occurs when the optical density of the space 16 is smaller than that of the space 18. In that case some of the light transmitted (or launched at the pipe's input) into the spaces 18 may be subject to total internal reflection and propagate through those spaces. This portion of light is to some degree similarly homogenized by the circular asymmetry provided by the outer side of surface 14. In either case, the polygonal surface 14 acts as a light integrator that homogenizes the portion of light 24 propagated inside it. Thus, due to the rotationally asymmetric profile of the surface 14 (acting both inwardly in space 16 and outwardly in space 18), the uniformity of irradiance of the light 24 propagating in the lightpipe is increased by the time it reaches the output facet 28. As a result of the continuous exchange of light between the regions 16 and 18 through the optical surface 14, the homogeneity of irradiance of the light 26 propagated in the space 18 is also further improved. Overall, therefore, the irradiance of the light output emanating at the plane 30 defining the end of the integrating portion of the ILP toward the circular aperture of the output facet 28 is optimized.

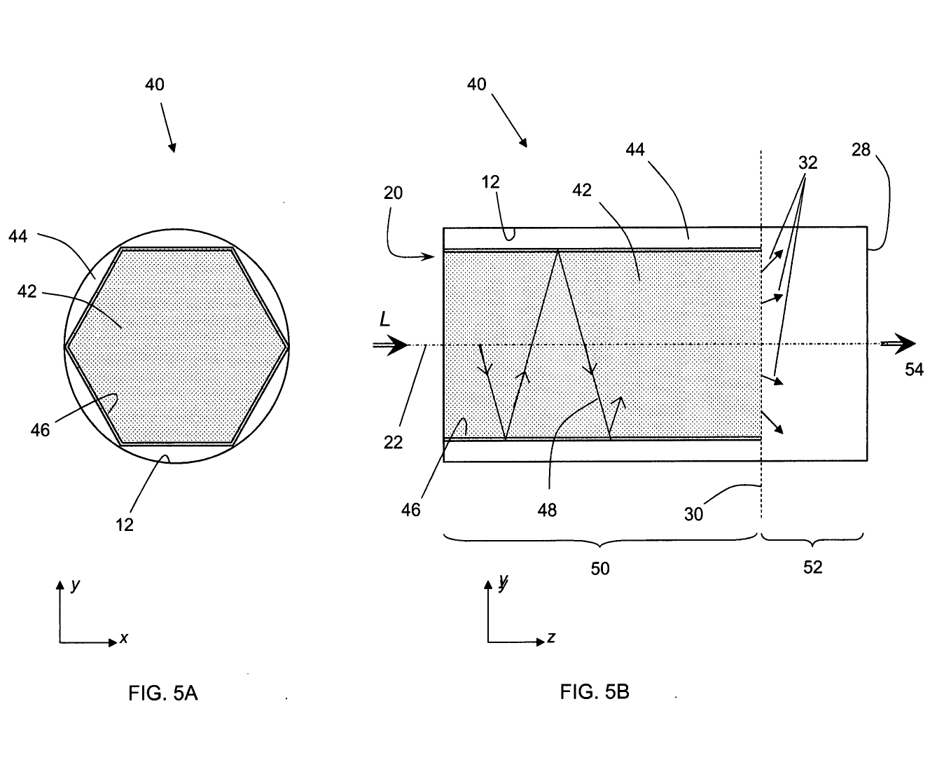

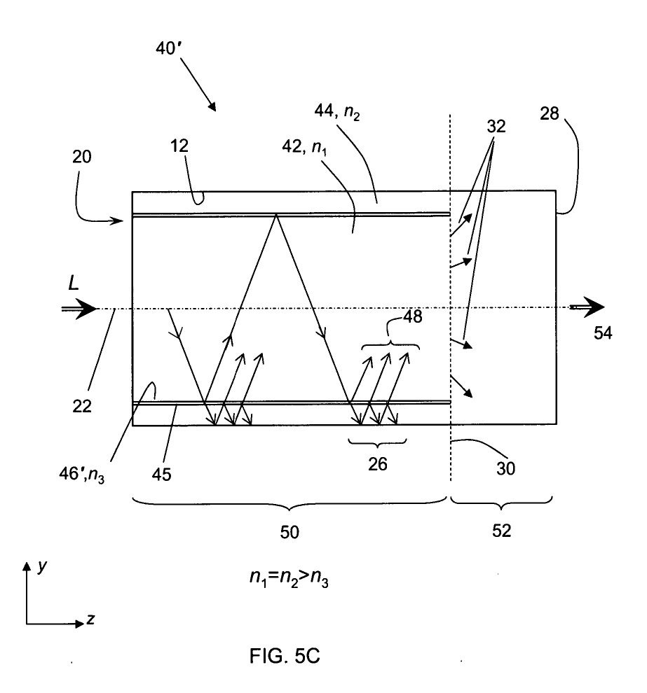

To further improve the homogenization of the light at the output facet 28, the interior asymmetric surface 14 is preferably terminated at a plane 30 ahead of the facet 28, as shown in FIG. 4B. In that case the light 24 homogenized inside the polygonal surface 14 emanates from it at the plane 30, as indicated with arrows 32, and spreads to the boundary of the reflective surface 12 as it propagates toward the output facet 28, thereby completely filling its circular aperture. This approach may be especially useful in another embodiment 40 of the invention shown in FIGS. 5A and 5B, wherein internal reflection of the light within the interior polygonal space 42 is achieved using a reflective layer 46 disposed between the inner and outer spaces 42 and 44 (a suitable reflector surface such as a common metallic layer, as illustrated in the figure, or preferably a low-index boundary to support TIR with surrounding media). The light 48 propagating through the rotationally asymmetric portion 50 of the ILP 40 (hexagonal, as shown) toward the output facet 28 by bouncing off the reflective layer 46 is homogenized in conventional fashion by the time it reaches the plane 30. The homogenized light 48 is further guided through the uniform, rotationally symmetric portion 52 of the ILP 40 by the reflective surface 12 and fills the circular output aperture 28. Thus, when a reflective layer 46 (such as a metal or a TIR material) is used, this embodiment will not generate any light propagation within the space 44 of the ILP 40 (unless launched into it at the input), and a certain amount of the light 48 may be absorbed upon interaction with the layer 46. If some exchange of light between the spaces 42 and 44 is desired, open polka-dot or similar patterns may be incorporated along the inner surface of the reflective layer 46 to allow some light transmission therethrough.

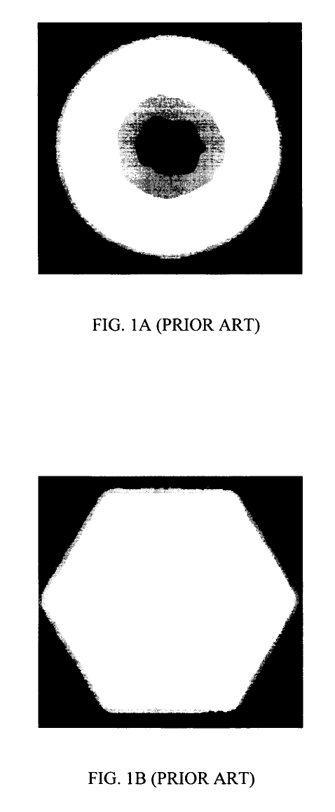

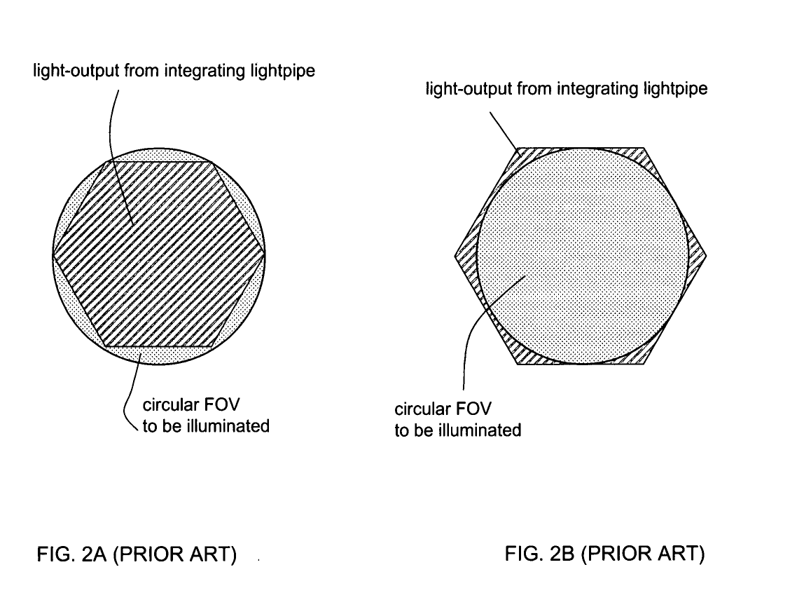

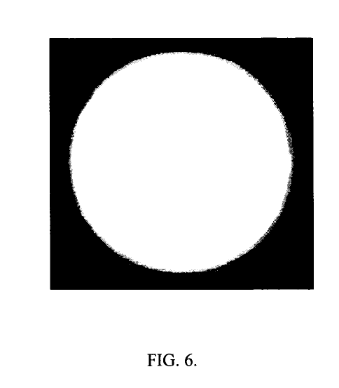

As one skilled in the art will readily understand, when some of the light is exchanged between the inner space (16,42) and the outer spaces (18,44) through the optical surface 14 (FIG. 4B) or the layer 46 (FIG. 5B), the refractive indices of the media will affect the angles of propagation of the light. When the indices are not substantially the same, the angle of propagation of some of the light will change along the length of the lightpipe, which is not desirable for maintaining uniform brightness. Therefore, the preferred embodiment 40′ of the invention is implemented with a thin layer 46′(in the order of a few microns) of low-index material between two media that have a substantially equal, but higher, index of refraction, as illustrated in FIG. 5C). Thus, to the extent that light is transmitted through the layer 46′, it is refracted and propagated through the pipe with the same angle incident upon the layer 46′. FIG. 6 illustrates the light-homogenizing performance of this configuration in an ILP 50-mm long, with a diameter of 10 mm, circumscribing a 40-mm long hexagonal glass rod coated with a 5-micron layer of low-index coating (such as a fluoropolymer), wherein all space 44 was filled with a material matching the index of the glass rod (n=1.52). This ILP was tested with an annular input source of light at 550 nanometers (10 mm OD, 5 mm ID, +/−40 degrees in air at pipe input). It is noted, for comparison, that the same input light was used to produce the prior-art examples of FIGS. 1A and 1B.

Although the embodiments 10, 40 and 40′ described above are arranged in similar fashion (i.e., they all comprise an outer structure with an inner reflective cylindrical surface enclosing a coaxial interior optical surface of polygonal cross-section), it is understood that any ILP consisting of an outer structure with a rotationally symmetric inner reflective surface and a rotationally asymmetric interior optical structure would mix the light to homogenize its irradiance and produce a substantially homogenized circular output according to the invention.

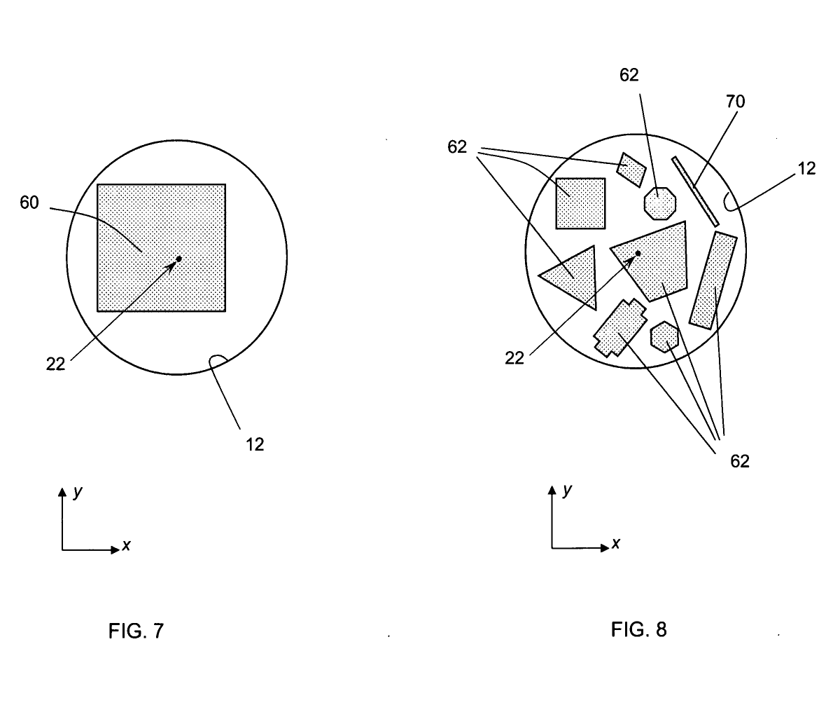

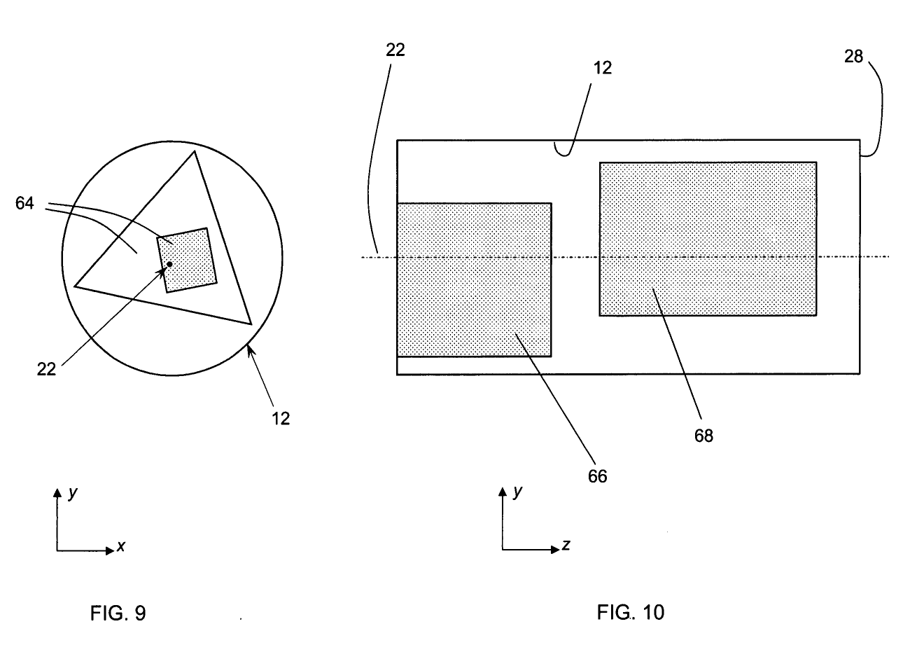

For example, the interior optical surface does not have to be coaxial with the circumscribing symmetric reflective surface. The interior structure 60 (illustrated as rectangular in FIG. 7, for example) may be displaced with respect to the optical axis 22. Similarly, FIG. 8 shows another embodiment where a plurality of rotationally asymmetric tubular structures 62 and/or plane boundaries 70 are incorporated within the rotationally symmetric reflecting surface 12 of an ILP to provide the same homogenization function according to the invention. Alternatively, as shown in FIG. 9, inner tubular structures 64 may be nested, either coaxially or off-axis, as illustrated. Among other purposes, such an arrangement (which increases the number of interactions with redistributing optical surfaces per unit length of pipe) may be used to create more compact integrating systems (with round or other output profiles).

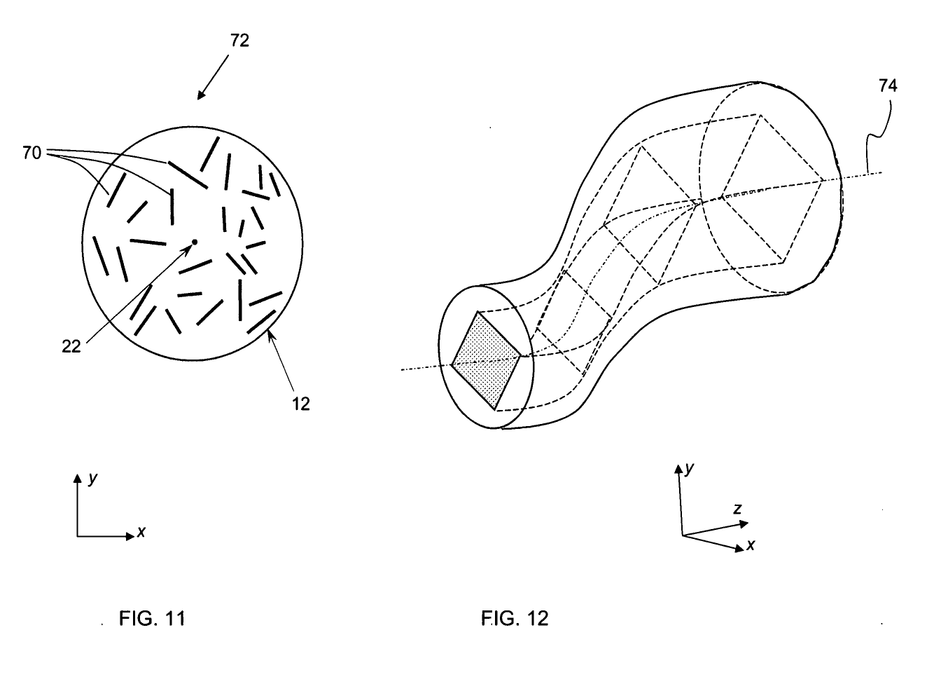

The ILP of the invention may also contain a plurality of (semi)reflective asymmetric boundaries disposed separately lengthwise, as shown in FIG. 10 where two polygonal surfaces 66 and 68 are placed sequentially and spaced apart along the length of the ILP. Moreover, as seen in FIG. 8, the rotationally asymmetric boundaries do not have to be continuous closed profiles to provide homogenization of light upon propagation through the ILP. For example, as shown in FIG. 11, a plurality of planar, optically reflective boundaries 70 disposed randomly lengthwise within the body of an ILP 72 can be used to homogenize light as a result of multiple irregular reflections during light propagation. As above, one purpose of such an arrangement may be to produce compact integrating systems.

Finally, the ILP of the invention is not restricted to an exterior structure with a cylindrical reflective surface. It may have a frustoconical or variable-diameter reflective surface and provide a similar degree of irradiance homogeneity. Moreover, the ILP may be bent along a curvilinear optical axis and still deliver a homogenized circular output as long as the interior rotationally-asymmetric homogenizing elements are disposed substantially lengthwise with respect to the optical axis, so as to prevent unwanted backward reflections. FIG. 12 illustrates this situation schematically. It is also noted that the optical media that may be utilized in the construction of the embodiments of the invention may include dielectric materials, metals, air or other materials as may be dictated by the performance objectives of the ILP. Such choice of materials would be well within the knowledge of one skilled in the art.

While the present invention has been shown and described herein in what is believed to be the most practical and preferred embodiments, it is recognized that departures can be made therefrom within the scope of the invention. Therefore, the invention is not to be limited to the details disclosed herein but is to be accorded the full scope of the claims so as to embrace any and all equivalent processes and products.

What is claimed is:

1. In a lightpipe including an outer structure with an inner reflective surface of rotationally symmetric cross-section, the improvement comprising:
at least one optically reflective, rotationally asymmetric surface disposed within the outer structure of the lightpipe.

2. The improvement of claim 1, wherein the at least one rotationally asymmetric surface is a tubular surface with a polygonal cross section.

3. The improvement of claim 2, wherein the tubular surface and the inner reflective surface of the outer structure are coaxial.

4. The improvement of claim 2, wherein a space between the reflective surface of the outer structure and the tubular surface has a different index of refraction from a space within the tubular surface.

5. The improvement of claim 2, wherein a space between the tubular surface and the reflective surface of the outer structure and a space within the tubular surface have a substantially equal first index of refraction; and further comprising a layer of material having a second index of refraction lower than said first index of refraction interposed between said spaces along said tubular surface.

6. The improvement of claim 2, wherein said tubular surface is shorter than a length of the lightpipe and removed from an output facet of the lightpipe.

7. The improvement of claim 1, wherein said at least one rotationally asymmetric surface is a planar surface.

8. The improvement of claim 1, wherein said inner reflective surface is frustoconical.

9. The improvement of claim 1, wherein said lightpipe has a curvilinear optical axis and said inner reflective surface of the outer structure is centered along said optical axis.

10. The improvement of claim 1, wherein said inner reflective surface of the outer structure has a variable diameter along an optical axis of the lightpipe.

11. A method of producing a light beam with a homogenized irradiance and a circular cross-section, comprising the following steps:
providing a lightpipe having an outer structure with an inner reflective surface of rotationally symmetric cross-section;
placing at least one optically reflective, rotationally asymmetric surface within the outer structure of the lightpipe;
launching an input beam of light into an input facet of the lightpipe; and
collecting an output beam of light from an output facet of the lightpipe.

12. The method of claim 11, wherein the at least one rotationally asymmetric surface is a tubular surface with a polygonal cross section.

13. The method of claim 12, wherein the tubular surface and the inner reflective surface of the outer structure are coaxial.

14. The method of claim 12, wherein a space between the reflective surface of the outer structure and the tubular surface has a different index of refraction from a space within the tubular surface.

15. The method of claim 12, wherein a space between the tubular surface and the reflective surface of the outer structure and a space within the tubular surface have a substantially equal first index of refraction; and further comprising the step of interposing a layer of material having a second index of refraction lower than said first index of refraction between said spaces along said tubular surface.

16. The method of claim 12, wherein said tubular surface is shorter than a length of the lightpipe and removed from an output facet of the lightpipe.

17. The method of claim 11, wherein said at least one rotationally asymmetric surface is a planar surface.

18. The method of claim 11, wherein said inner reflective surface is frustoconical.

19. The method of claim 11, wherein said lightpipe has a curvilinear optical axis and said inner reflective surface of the outer structure is centered along said optical axis.

20. The method of claim 11, wherein said inner reflective surface of the outer structure has a variable diameter along an optical axis of the lightpipe.
